(19) United States
(12) Patent Application Publication
(10) Pub. No.: US 2019/0204882 A1
(43) Pub. Date: Jul. 4, 2019

(54) Computer System And Its Power Adapter Having Input / Output Connection Interfaces

(71) Applicant: Quanta Computer Inc., Taoyuan City (TW)

(72) Inventors: Fang-Hsiang Tseng, Taoyuan City (TW); Yung-Shun Ho, Taoyuan City (TW)

(21) Appl. No.: 15/949,579

(22) Filed: Apr. 10, 2018

(30) Foreign Application Priority Data
Jan. 2, 2018 (TW) 107100103

(51) Int. Cl. G06F 1/18; H01R 27/02; H02J 7/02; G06F 1/16; G06F 21/32; G06F 1/28; G06F 13/40

(52) U.S. Cl. CPC G06F 1/189; H01R 27/02; H02J 7/025; G06F 2213/0042; G06F 21/32; G06F 1/28; G06F 13/4081; G06F 1/1632

(57) ABSTRACT

A computer system includes a computer device and a power adapter. The computer device is provided with a first signal connector. The power adapter includes a second signal connector, a rectifier and an input/output board module. The second signal connector is pluggably connected to the first signal connector. The input/output board module is electrically connected to the second signal connector for being detachably connected to an external device so as to allow signals to be exchanged between the computer device and the external device.

### RELATED APPLICATIONS

This application claims priority to Taiwan Application Serial Number 107100103, filed Jan. 2, 2018, which is herein incorporated by reference.

### BACKGROUND

### Field of Disclosure

The present disclosure relates to a power adapter. More particularly, the present disclosure relates to a power adapter having input/output connection interfaces.

### Description of Related Art

In general, the exterior design of a notebook computer is continuously developed towards smallness, thinness and lightness and portability, thereby allowing a user to carry the notebook computer conveniently.

For example, in a conventional notebook computer, functional components such as a standard I/O port and a fingerprint identification area which are configured on a main machine of the conventional notebook computer occupy a certain amount of space, thus resulting in a bottleneck of the exterior design of the conventional notebook computer developed towards smallness, thinness and lightness that requires to be further improved.

Therefore, how to develop a solution to effectively overcome the aforementioned inconveniences and disadvantages is an urgent and important topic for the industry.

### SUMMARY

According to one embodiment, a power adapter includes a device body, a rectifier and an input/output board module. The device body is provided with a signal connector. The rectifier is disposed in the device body, and is electrically connected to the signal connector. The input/output board module is disposed in the device body, and is electrically connected to the signal connector and the rectifier for pluggably connecting to an external device.

In one or more embodiments of the disclosure, the power adapter further includes a fingerprint module. The fingerprint module is disposed on the device body, and is electrically connected to the rectifier, the signal connector and the input/output board module.

In one or more embodiments of the disclosure, the power adapter further includes a wireless charging module. The wireless charging module is disposed on the device body, and is electrically connected to the rectifier for electrically charging a wireless device in a wireless way.

In one or more embodiments of the disclosure, the power adapter further includes an independent display module. The independent display module is disposed on the device body, and is electrically connected to the rectifier and the signal connector.

In one or more embodiments of the disclosure, the device body is formed with a pen slot for receiving a stylus pen.

In one or more embodiments of the disclosure, the input/output board module includes a variety of connection ports, in which one of the connection ports is selected from a group consisting of an Ethernet port, an audio port, a USB 2.0 port, a USB 3.0 port, a USB type-C interface, a memory card slot, a VGA port and an HDMI port.

According to another embodiment, a computer system includes a computer device and a power adapter. The computer device is provided with a first signal connector. The power adapter includes a device body, a rectifier and an input/output board module. The device body is provided with a second signal connector. The second signal connector is pluggably connected to the first signal connector. The rectifier is disposed in the device body, and is electrically connected to the second signal connector. The input/output board module is disposed in the device body, and is electrically connected to the second signal connector for pluggably connecting to an external device, so as to allow signals to be exchanged between the computer device and the external device.

In one or more embodiments of the disclosure, the power adapter further includes a fingerprint module. The fingerprint module is disposed on the device body, and is electrically connected to the second signal connector. Thus, when the fingerprint module receives a fingerprint signal and verifies that the fingerprint signal is valid, in response thereto, the fingerprint module allows the computer device to be unlocked.

In one or more embodiments of the disclosure, the power adapter further includes a fingerprint module. The fingerprint module is disposed on the device body, and is electrically connected to the second signal connector and the input/output board module. Thus, when the fingerprint module receives a fingerprint signal and verifies that the fingerprint signal is valid, in response thereto, the fingerprint module allows the signals to be exchanged between the computer device and the external device.

In one or more embodiments of the disclosure, the power adapter further includes a fingerprint module. The fingerprint module is disposed on the device body, and is electrically connected to the rectifier and the second signal connector. Thus, when the fingerprint module receives a fingerprint signal and verifies that the fingerprint signal is valid, in response thereto, the fingerprint module allows power to supplied from the power adapter to the computer device.

Thus, in the above embodiments, since most of the I/O ports have been eliminated from the computer device, the computer device can be developed towards an ultra-thin appearance in size so as to provide convenience for a user to carry and store the computer device, thereby increasing user's preferences.

The above description is merely used for illustrating the problems to be resolved, the technical methods for resolving the problems and their efficacies, etc. The specific details of the present disclosure will be explained in the embodiments below and related drawings.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

In the drawings,

FIG. 1 is a schematic diagram of a computer system according to one embodiment of the disclosure;

FIG. 2 is an electronic block diagram of the computer system of FIG. 1;

FIG. 3 is an exploded view of the power adapter of FIG. 1; and

FIG. 4 is an electronic block diagram of a computer system according to another embodiment of the disclosure.

### DESCRIPTION OF THE EMBODIMENTS

Reference will now be made in detail to the present embodiments of the disclosure, examples of which are illustrated in the accompanying drawings. Wherever possible, the same reference numbers are used in the drawings and the description to refer to the same or like parts. According to the embodiments, it will be apparent to those skilled in the art that various modifications and variations can be made to the structure of the present disclosure without departing from the scope or spirit of the disclosure.

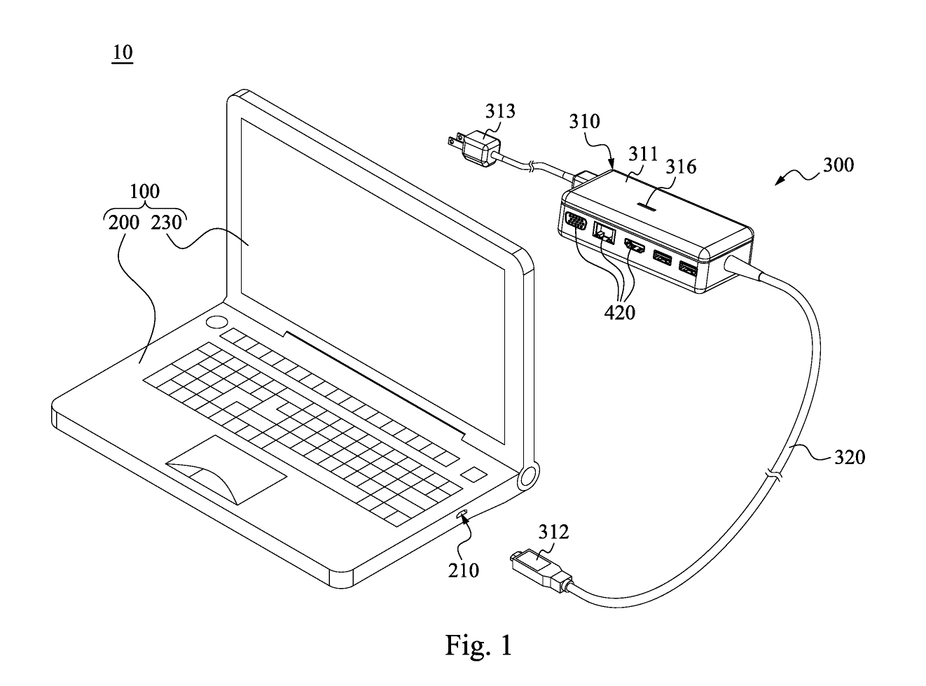

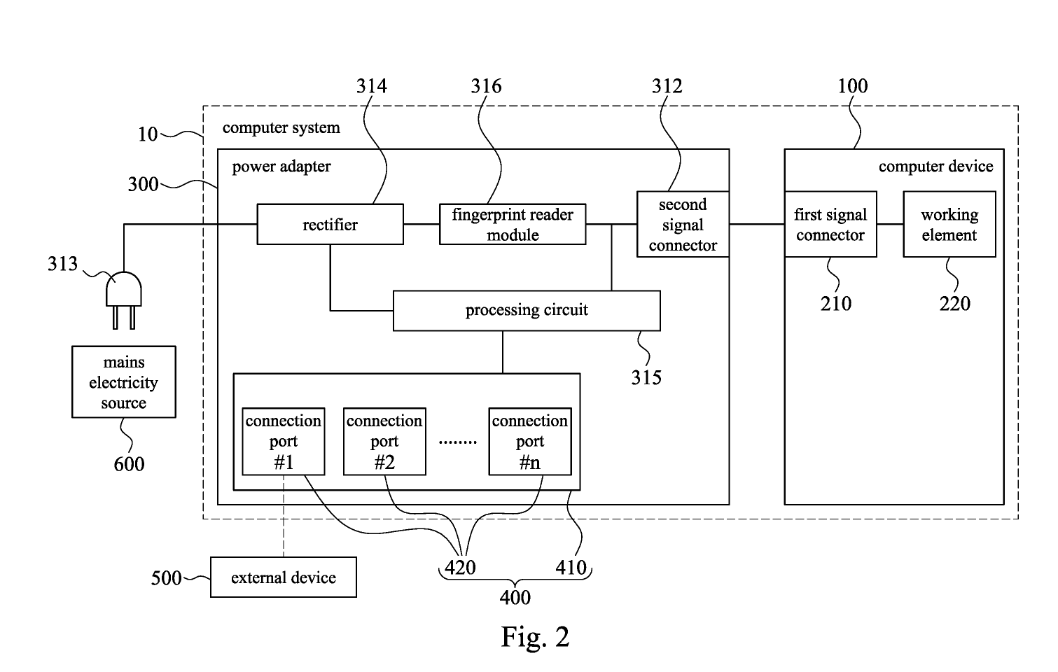

Reference is now made to FIG. 1 to FIG. 2 in which FIG. 1 is a schematic diagram of a computer system according to one embodiment of the disclosure, and FIG. 2 is an electronic block diagram of the computer system of FIG. 1. The computer system 10 includes a computer device 100 and a power adapter 300. The power adapter 300 includes a device body 310, a cable cord 320, a rectifier 314 and an input/output (I/O) board module 400. The rectifier 314 is disposed in the device body 310, and the rectifier 314 is used for rectifying and transforming the alternating current of mains electricity to direct current, and transmitting the direct current to the computer device 100. The rectifier 314 is electrically connected to the computer device 100 through the cable cord 320. The input/output board module 400 is electrically connected to the computer device 100 through the cable cord 320. When at least one external device 500 is pluggably connected to the input/output board module 400, the external device 500 and the computer device 100 are electrically connected to each other through the input/output board module 400 so that signals can be exchanged from the computer device 100 to the external device 500, and from the external device 500 to the computer device 100. In a specific embodiment, the external device 500, for example, is a screen or a USB disk.

In the embodiment, the computer device 100 is provided with a first signal connector 210 and a working element 220. The working element 220 is electrically connected to the first signal connector 210. Specifically, the computer device 100 includes a main machine 200 and a display unit 230. The display unit 230 is pivotally connected to the main machine 200. The main machine 200 has a single first signal connector 210, and in a specific embodiment, the main machine 200 may only has the single first signal connector 210 as described above without other signal connectors, so as to make the overall computer device 100 become thinner and lighter. The first signal connector 210 is a USB type-C interface port, for example. The computer device 100 is a notebook computer, but the present disclosure is not limited thereto. In another embodiment, the computer device 100 may also be a smart phone or the like. One end of the cable 320 has a second signal connector 312. The second signal connector 312 of the power adapter 300 is pluggably and electrically connected to the first signal connector 210. The power adapter 300 further includes a power plug 313 and a processing circuit 315. The power plug 313 is removably connected to the device body 310, and is electrically connected to the rectifier 314. The processing circuit 315, the rectifier 314 and the input/output board module 400 are respectively located in an outer casing 311 of the device body 310. The processing circuit 315 is electrically connected to the second signal connector 312, the rectifier 314 and the input/output board module 400. By connecting the second signal connector 312 to the first signal connector 210, the processing circuit 315 can be electrically connected to the computer device 100. The processing circuit 315 is a processing chip set (e.g., Thunderbolt-Alpine Ridge), for example.

Thus, when the power plug 313 of the power adapter 300 is electrically connected to a mains electricity source 600, and the power adapter 300 is electrically connected to the first signal connector 210 through the second signal connector 312, the power adapter 300 provides power to the computer device 100 so as to allow the working element 220 to operate normally. In the embodiment, the working element 220 generally represents any conventional working module, component or circuit in the computer device 100. In addition, the processing circuit 315 is used to control the input/output board module 400 to enable the computer device 100 to exchange signals with the aforementioned external device 500.

In the embodiment, the input/output board module 400 includes a circuit board 410 and a variety of connection ports 420 (e.g., connection ports #1 to #n shown in FIG. 2). The connection ports 420 are arranged on the circuit board 410, and are respectively exposed outwards from at least one side of the outer casing 311 of the device body 310. However, the disclosure is not limited to the types of the connection ports 420, and the types the connection ports 420 may be configured to be the input/output board module 400 in accordance with requirements. For example, one of the connection ports 420 can be an Ethernet port (e.g., RJ45), an audio port (e.g., audio jack), a USB 2.0 port, a USB 3.0 port, a USB type-C interface, a memory card slot (e.g., SD or micro SD card), a VGA port or an HDMI port, however, the disclosure is not limited thereto.

Thus, in the above embodiment, since most of the I/O ports have been eliminated from the computer device 100, the computer device 100 can be developed towards an ultra-thin appearance in size so as to allow a user to carry and store the computer device conveniently, thereby increasing user's preferences.

In the embodiment, the power adapter 300 further includes a fingerprint module 316. The fingerprint module 316 is disposed in the device body 310, and exposed outwards from the outer casing 311 of the device body 310. The fingerprint module 316 is electrically connected to the rectifier 314, the input/output board module 400 and the computer device 100. The fingerprint module 316 is used to receive a fingerprint signal and to verify whether the fingerprint signal is valid.

In one arrangement of the embodiment, when the fingerprint module 316 receives a fingerprint signal and verifies that the fingerprint signal is valid, in response thereto, the fingerprint module 316 allows the computer device 100 to be unlocked from a sleep mode. For example, the fingerprint module 316 notifies the corresponding working element 220 (e.g., unlocking unit) in the computer device 100 to unlock the computer device 100 from the sleep mode; and on the other hand, when the fingerprint module 316 verifies that the fingerprint signal is not valid, in response thereto, the fingerprint module 316 does not allow the computer device 100 to be unlocked from the sleep mode.

In one arrangement of the embodiment, when the fingerprint module 316 receives a fingerprint signal and verifies that the fingerprint signal is valid, in response thereto, the fingerprint module 316 allows the signals to be exchanged from the computer device 100 to the external device 500, and from the external device 500 to the computer device 100. For example, the fingerprint module 316 notifies the corresponding working element 220 (e.g., CPU) in the computer device 100, so that the corresponding working element 220 (e.g., CPU) of the computer device 100 can be electrically connected to the input/output board module 400 through the processing circuit 315. Thus, the computer device 100 and the external device 500 are able to exchange signals with each other through the input/output board module 400; and on the other hand, when the fingerprint module 316 verifies that the fingerprint signal is not valid, in response thereto, the fingerprint module 316 does not allow the computer device 100 and the external device 500 to exchange signals with each other.

In one arrangement of the embodiment, when the fingerprint module 316 receives a fingerprint signal and verifies that the fingerprint signal is valid, in response thereto, the power adapter 300 is allowed to provide power to the computer device 100. For example, the fingerprint module 316 sends a preset signal to a corresponding working element 220 in the computer device 100, and the working element 220 is switched to electrically connect the power adapter 300 and the computer device 100; and on the other hand, when the fingerprint module 316 verifies that the fingerprint signal is not valid, in response thereto, the fingerprint module 316 notifies the working element 220 to keep disconnecting the power adapter 300 from the computer device 100. Therefore, even though the cable 320 is physically connected to both of the computer device 100 and the power adapter 300, the computer device 100 cannot receive power from the power adapter 300 without a valid fingerprint signal, thereby providing anti-theft effectiveness.

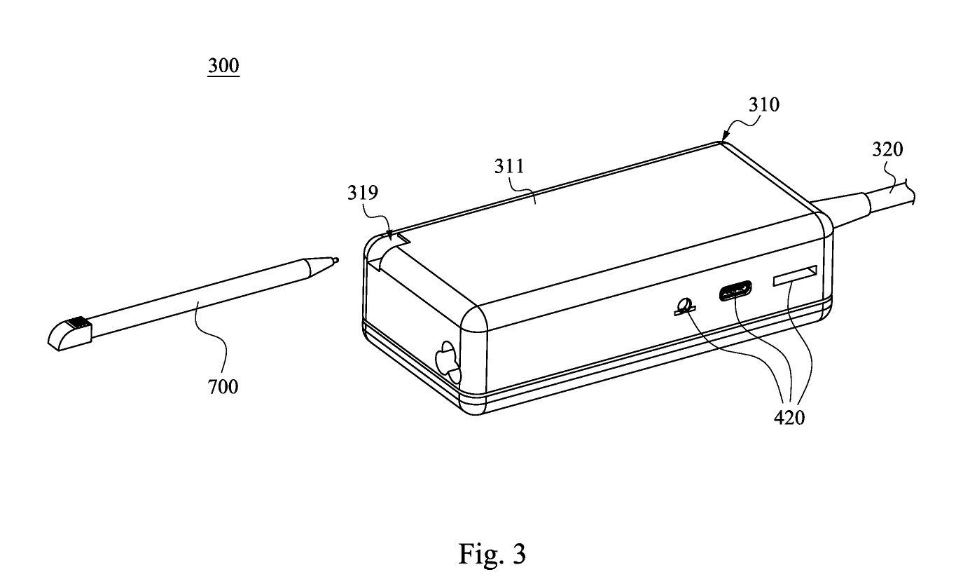

FIG. 3 is an exploded view of the power adapter of FIG. 1. As shown in FIG. 1 and FIG. 3, the device body 310 includes a pen slot 319. The pen slot 319 is formed on one side of the outer casing 311 of the device body 310 for receiving a stylus pen 700. The display screen 230 is a touch display screen, for example, and the stylus 700 is used to operate the touch display screen.

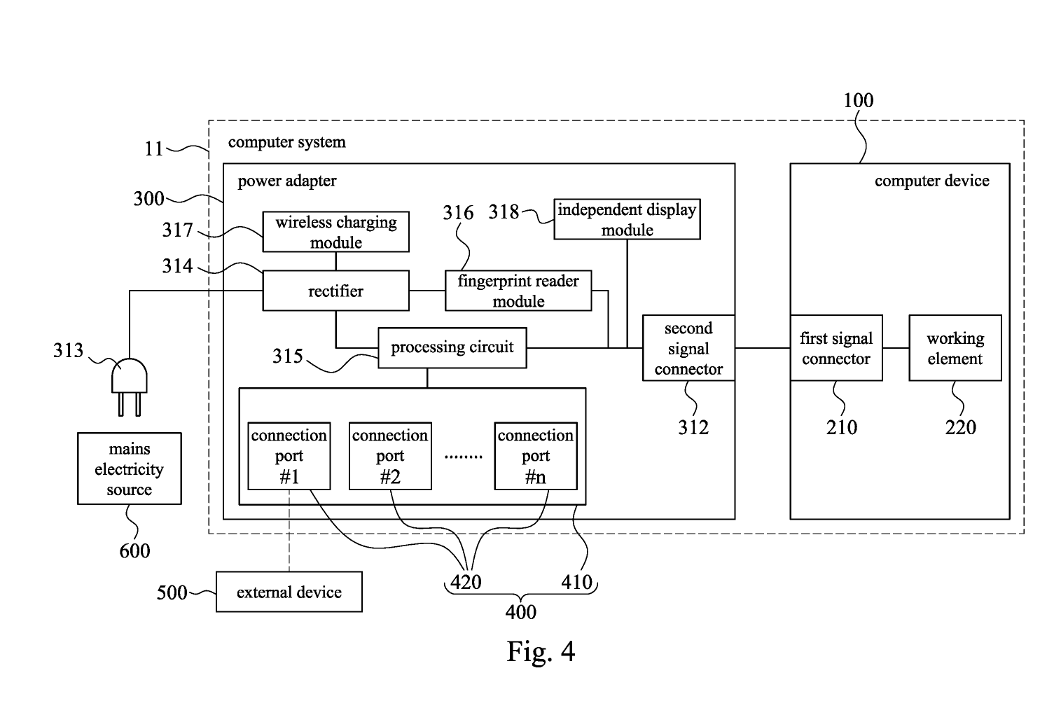

FIG. 4 is an electronic block diagram of a computer system 11 according to another embodiment of the disclosure. As shown in FIG. 4, in the embodiment, the computer system 11 of FIG. 4 and the computer system 10 of FIG. 2 are substantially the same, in which the same elements are labeled with the same numerical references in FIG. 4. However, at least one difference of the computer system 11 of FIG. 4 from the computer system 10 of FIG. 2 is that, the power adapter 300 further includes a wireless charging module 317. The wireless charging module 317 is electrically connected to the rectifier 314 for electrically charging a wireless device in a wireless way. For example, the wireless charging module 317 is disposed in the outer casing 311 of the device body 310 near one side of the device body 310. Therefore, no matter whether the power adapter 300 is electrically connected to the computer device 100 via the cable 320, when the power plug 313 is electrically connected to a mains electricity source 600, the wireless charging module 317 may electrically charge the wireless device (e.g., smart phone) in a wireless way.

Furthermore, the power adapter 300 further includes an independent display module 318. The independent display module 318 is disposed in the device body 310 and electrically connected to the rectifier 314, and is electrically connected to the computer device 100 via the cable 320 for providing the computer device 100 with better image computing capability and image output performance.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims and their equivalents.

What is claimed is:

1. A power adapter, comprising:
a device body having a signal connector;
a rectifier that is disposed in the device body and is electrically connected to the signal connector;
an input/output board module that is disposed in the device body and is electrically connected to the signal connector and the rectifier, thereby pluggably connecting to an external device.

2. The power adapter of claim 1, further comprising:
a fingerprint module that is disposed on the device body and is electrically connected to the rectifier, the signal connector and the input/output board module.

3. The power adapter of claim 1, further comprising:
a wireless charging module that is disposed on the device body and is electrically connected to the rectifier, thereby electrically charging a wireless device in a wireless way.

4. The power adapter of claim 1, further comprising:
an independent display module that is disposed on the device body and is electrically connected to the rectifier and the signal connector.

5. The power adapter of claim 1, wherein the device body has a pen slot for receiving a stylus pen.

6. The power adapter of claim 1, wherein the input/output board module includes a variety of connection ports, and one of the connection ports is selected from a group consisting of an Ethernet port, an audio port, a USB 2.0 port, a USB 3.0 port, a USB type-C interface, a memory card slot, a VGA port and an HDMI port.

7. A computer system, comprising:
a computer device having a first signal connector; and
a power adapter, comprising:
a device body having a second signal connector pluggably connected to the first signal connector;
a rectifier that is disposed in the device body and is electrically connected to the second signal connector; and
an input/output board module that is disposed in the device body and is electrically connected to the second signal connector for pluggably connecting to an external device, so as to allow signals to be exchanged between the computer device and the external device.

8. The computer system of claim 7, wherein the power adapter further comprises:
a fingerprint module that is disposed on the device body and is electrically connected to the second signal connector,
wherein, when the fingerprint module receives a fingerprint signal and verifies that the fingerprint signal is valid, the fingerprint module allows the computer device to be unlocked in response thereto.

9. The computer system of claim 7, wherein the power adapter further comprises:
a fingerprint module that is disposed on the device body and is electrically connected to the second signal connector and the input/output board module,
wherein, when the fingerprint module receives a fingerprint signal and verifies that the fingerprint signal is valid, the fingerprint module allows the signals to be exchanged between the computer device and the external device in response thereto.

10. The computer system of claim 7, wherein the power adapter further comprises:
a fingerprint module that is disposed on the device body and is electrically connected to the rectifier and the second signal connector,
wherein, when the fingerprint module receives a fingerprint signal and verifies that the fingerprint signal is valid, the fingerprint module allows power to be supplied from the power adapter to the computer device.
